(19) United States
(12) Patent Application Publication
(10) Pub. No.: US 2015/0044348 A1
(43) Pub. Date: Feb. 12, 2015

(54) New use for a compound of vanillin and ethyl vanillin in a food product

(71) Applicant: RHODIA OPERATIONS, Paris (FR)

(72) Inventors: Dominique Giannotta, Communay (FR); Corine Cochennec, Voiron (FR); Tristan Colas Des Francs, Lyon (FR); Sandrine Bodin, Garches (FR); Bernard Barlet, Lyon (FR)

(21) Appl. No.: 14/390,580

(22) PCT Filed: Mar. 28, 2013
(86) PCT No.: PCT/EP2013/056804

§ 371 Date: Oct. 3, 2014

(30) Foreign Application Priority Data
Apr. 4, 2012 (FR) 1253112

(51) Int. Cl. A23L 1/226; A23K 1/16; A23G 3/36; A21D 13/08; A23G 1/32

(52) U.S. Cl. CPC A23L 1/22657; A21D 13/08; A23G 1/32; A23G 3/36; A23K 1/1612; A23V 2002/00
USPC 426/538; 426/650

(57) ABSTRACT

The present invention concerns a new use for a compound of vanillin and ethyl vanillin, in a food product and more particularly in a food product with a reduced fat and/or sugar content. The present invention also concerns food compositions comprising said compound of vanillin and ethyl vanillin.

The present invention relates to a new use of a compound of vanillin and ethyl vanillin in a food product and more particularly in a food product with a reduced fat and/or sugar content.

The present invention also relates to food compositions comprising said compound of vanillin and ethyl vanillin.

Food products with a reduced fat and/or sugar content are of real interest for public health and for the food industry.

This is because products with a reduced fat and/or sugar content are beneficial to consumers' health. They make it possible to decrease fat and/or sugar intake, it being known that the consumption of too much fat and/or sugar can in particular represent a cardiovascular and obesity risk factor.

Furthermore, fats are in particular among the most expensive raw materials in the preparation of food products. Reducing the fat content in the use of recipes therefore leads to a decrease in cost of the food product, which is advantageous for the industries in the sector.

It is important that products with a reduced fat and/or sugar content have a taste that is identical or similar to products with a non-reduced fat and/or sugar content, so that their consumption is pleasant and in order to guarantee an organoleptic quality.

However, products with a reduced fat and/or sugar content exhibit a loss of roundness in the mouth and a loss of flavoring(s) compared with products with a non-reduced fat and/or sugar content. Indeed, by virtue of the reduction in the amount of fats, the sensation of roundness in the mouth, provided by the fats themselves, decreases. Furthermore, fats act as flavoring retainers. More specifically, they bind flavorings. Consequently, the more the amount of fats is reduced, the less the flavorings are retained in the food product.

Flavorings can volatilize, in particular during cooking. Thus, during their preparation, food products can be subjected to very substantial heat treatments, which can greatly decrease their flavoring content, in particular if there are fewer fats to retain said flavorings.

One of the flavorings most widely used in the food industry is vanillin, or 4-hydroxy-3-methoxybenzaldehyde. However, this flavoring does not notably confer a gustatory sensation of roundness in the mouth and does not make it possible to effectively overcome both the loss of roundness in the mouth and the loss of flavoring(s) of food products with a reduced fat and/or sugar content.

There is therefore a need to provide a compound which makes it possible to confer a gustatory sensation of roundness in the mouth, in particular in products with a reduced fat and/or sugar content.

The aim of the present invention is to provide a compound which confers a sensation of roundness in the mouth in food products, and more particularly to provide a compound which makes it possible to compensate for the loss both of roundness in the mouth and of flavoring(s) in products with a reduced fat and/or sugar content.

The subject of the present invention is therefore the use, in a food product, of a compound of vanillin and ethyl vanillin in a vanillin/ethyl vanillin molar ratio of 2, having a melting point of 60° C.±2° C., for conferring a gustatory sensation of roundness in the mouth. The present invention also relates to the use, in a food product, of a compound of vanillin and ethyl vanillin in a vanillin/ethyl vanillin molar ratio of 2, having a melting point of 60° C.±2° C., for reinforcing a gustatory sensation of roundness in the mouth.

According to one particular mode of the invention, the compound of vanillin and ethyl vanillin used has an x-ray diffraction spectrum with several characteristic lines at angles 2θ (in)°=20.7−25.6−27.5−28.0 (measured relative to the copper K-Alpha1 line=1.54060 Å), said lines not being present in the x-ray diffraction spectrum of pure vanillin or of pure ethyl vanillin.

The compound of vanillin and ethyl vanillin is described as a flavoring in food products in patent application EP 2 365 760.

It has now been discovered, surprisingly, that this compound also makes it possible to confer and/or to reinforce a gustatory sensation of roundness in the mouth.

It has also been found, surprisingly, that said compound makes it possible to compensate for both the loss of roundness in the mouth and the loss of flavoring(s) in products with a reduced fat and/or sugar content.

This is because the compound of vanillin and ethyl vanillin advantageously has a greater solubility in fats than vanillin, thereby allowing it to be retained to a greater extent and to be more available in fats and thus to compensate for the abovementioned losses. The term “retained in fats” is intended to mean the fact that the compound of vanillin and ethyl vanillin solubilizes in the fats and thus remains “imprisoned” and protected by them. In particular, the compound of vanillin and ethyl vanillin is soluble in cocoa butter in an amount of 5.9% by weight, compared with a maximum solubility of pure vanillin in cocoa butter equal to 2.8% by weight and a maximum solubility of pure ethyl vanillin in cocoa butter equal to 3.7% by weight.

Said compound is obtained by co-crystallization of vanillin and ethyl vanillin in a molar ratio of 2, and has its own specific characteristics. It can be obtained by means of the processes described in patent applications EP 2 365 760, WO 2011/042365 and WO 2011/104208. According to one embodiment, the vanillin/ethyl vanillin weight ratio is advantageously between 70/30 and 65/35.

It is in the form of a white powder with a melting point measured by differential calorimetric analysis of 60° C.±2° C. different than that of vanillin and of ethyl vanillin, respectively, of 81° C.±1° C. and of 76° C.±1° C.

The compound of vanillin and ethyl vanillin has an x-ray diffraction spectrum which is specific thereto and which is different than that of vanillin and of ethyl vanillin.

On the spectrum of the compound based on vanillin and ethyl vanillin, the presence of lines at angles 2θ (in)°=20.7−25.6−27.5−28.0 (measured relative to the copper K-Alpha1 line=1.54060 Å) is in particular noted, said lines being absent on the x-ray diffraction spectra of vanillin and of ethyl vanillin.

Another characteristic of the compound of vanillin and ethyl vanillin is that its x-ray diffraction spectrum does not undergo any significant change during prolonged storage.

Another characteristic of this compound is that it is a compound that is non-hygroscopic or very sparingly hygroscopic, like vanillin and ethyl vanillin.

The hygroscopy of this compound is determined by measuring its variation in weight after having been kept for 1 hour at 40° C. in air at 80% relative humidity.

Said compound adsorbs less than 0.5% by weight of water, its content preferably being between 0.1% and 0.3% by weight of water. Said compound remains perfectly solid.

The compound of vanillin and ethyl vanillin has good organoleptic properties.

It has a high aromatic power, much higher than that of vanillin. Thus, in its applications as a flavoring, it is possible to use smaller amounts, for example half the amount, without noting any difference in aromatic power. It also has an aromatic power greater than that of a vanillin flavoring and of an ethyl vanillin flavoring introduced separately into a food product.

In accordance with (EC) regulation No. 178/2002 and according to the terms of the present invention, the term “food product” (also called “food”) is intended to mean any perishable or nonperishable, transformed, partially transformed or nontransformed substance or product intended to be ingested or reasonably likely to be ingested by human beings. The term “food product” is also intended to mean the coverings, the coatings and other conditionings which are intended to be consumed at the same time as the basic product, or for which simultaneous consumption is anticipated. The present invention also applies to products for feeding animals.

For the purposes of the invention, a food product with a reduced fat and/or sugar content, also called low-fat and/or -sugar product in the context of the present invention, is a food product of which the fat and/or sugar content has been decreased compared with a food product of which the fat and/or sugar content has not been decreased.

According to one particular mode of the invention, a food product with a reduced fat and/or sugar content is a product of which the amount of fat(s) and/or of sugar(s) is decreased by at least 0.1% by weight, preferably by at least 0.5% by weight, more preferably by at least 1% by weight and even more preferably by at least 5% by weight, relative to the amount of fat(s) and/or of sugar(s) in a food product with a non-reduced fat and/or sugar content. Advantageously, the amount of fat(s) and/or of sugar(s) is decreased by at most 80% by weight, preferably by at most 50% by weight, more preferably by at most 30% by weight and even more preferably by at most 25% by weight, relative to the amount of fat(s) and/or of sugar(s) in a food product with a non-reduced fat and/or sugar content.

The term “gustatory sensation” is intended to mean the sensation of taste, of sapidity conferred by food products when they are consumed. The gustatory sensation comprises all the common gustatory and olfactory sensations perceived when foods are in the mouth.

The term “conferring a gustatory sensation” is intended to mean giving a food product the desired gustatory properties.

The term “reinforcing a gustatory sensation” is intended to mean making more intense, accentuating, increasing the gustatory sensation normally conferred by the food product.

The term “flavoring” is intended to mean any product or substance which is intended to be added to food products in order to give them an odor, a taste, or an odor and a taste. The flavoring is perceived when a food is ingested in the back of the mouth at olfactory sites in the upper part of the nasal fossae. The flavoring of a food is in particular due to a complex mixture of volatile compounds.

The term “roundness in the mouth” corresponds in particular to a creamy taste, to a milk fat taste, to a butter taste, to a sweet taste, to adhesion and/or fullness in the mouth. The roundness in the mouth is a pleasant gustatory sensation for the consumer, who perceives the tasted product as smooth, unctuous, creamy, sweet and/or sweetened.

The loss of flavoring and of roundness in the mouth due to a decrease in the amounts of fat(s) and/or of sugar(s) in a food product results in a gustatory sensation with fewer flavors, fewer softness, unctuousness, creaminess, sweetness, sweetened and/or vanilla sensations. The products appear to be insipid and less pleasant when consumed.

According to one embodiment, in the use according to the invention, the gustatory sensation of roundness in the mouth is characterized by at least one taste sensation chosen from the set comprising a creamy taste, a milk fat taste, a butter taste, a sweet taste, adhesion and fullness in the mouth.

Such an effect is particularly sought in order to compensate for the loss of roundness in the mouth, the loss of flavoring(s) or the insipid nature of low-fat and/or -sugar food products due to the reduction in the amount of fat(s) and/or of sugar(s).

In accordance with the invention, said compound of vanillin and ethyl vanillin is used in a food product with a reduced fat and/or sugar content, for example in a product of which the amount of fat(s) and/or of sugar(s) is decreased by at least 0.1% by weight, preferably by at least 0.5% by weight, more preferably by at least 1% by weight and even more preferably by at least 5% by weight, relative to the amount of fat(s) and/or of sugar(s) in a food product with a non-reduced fat and/or sugar content. Advantageously, said compound of vanillin and ethyl vanillin is used in a food product with a reduced fat and/or sugar content, for example in a product of which the amount of fat(s) and/or of sugar(s) is up to 80% by weight, preferably up to 50% by weight, more preferably up to 30% by weight and even more preferably up to 25% by weight decreased, relative to the amount of fat(s) and/or of sugar(s) present in a food product with a non-reduced fat and/or sugar content.

According to one embodiment, the invention relates to the use of said compound of vanillin and ethyl vanillin for compensating for the loss of flavoring and the loss of roundness in the mouth due to a decrease of at least 0.1% by weight, preferably of at least 0.5% by weight, more preferably of at least 1% by weight and even more preferably of at least 5% by weight in the amount of fat(s) and/or of sugar(s) in a food composition with a reduced fat and/or sugar content compared with a food composition with a non-reduced fat and/or sugar content. Advantageously, the use of said compound of vanillin and ethyl vanillin compensates for the loss of flavoring and the loss of roundness in the mouth due to a decrease of at most 80% by weight, preferably of at most 50% by weight, more preferably of at most 30% by weight and even more preferably of at most 25% by weight in the amount of fat(s) and/or of sugar(s) in a food composition with a reduced fat and/or sugar content compared with a food composition with a non-reduced fat and/or sugar content.

The term “compensating for” is intended to mean making up for, correcting or off-setting the loss of roundness in the mouth, the loss of flavoring(s) or the insipid nature of the food products with a reduced fat and/or sugar content.

Food fats include all solid fats and oils which are edible. They may be of animal or vegetable origin.

Fats are grouped into four main categories:

Animal fats. The main food animal fats are: duck fat, goose fat, beef kidney fat, dripping and lard.

Butter, which is obtained from milk fats. Semi-solid fats of vegetable origin, such as cocoa butter and shea butter are also called “butter”. In the context of the present invention, butter and all its derivatives are involved, in particular concentrated butter, kitchen butter, pastry butter, half-fat butter and low-fat butter.

Margarine, which is an emulsion composed of fats and oils (hydrogenated or nonhydrogenated) dispersed in water. The main margarines are rapeseed margarine, olive oil margarine, soya margarine and sunflower margarine.

Vegetable oils and butter oil of animal origin. The main food vegetable oils are: almond oil, peanut oil, avocado oil, safflower oil, rapeseed oil, coconut oil, marrow seed oil, corn oil, hazelnut oil, walnut oil, macadamia nut oil, olive oil, palm oil, palm kernel oil, grapeseed oil, sesame oil, soybean oil and sunflower oil. Eucalyptus oil, argan oil, mustard oil and Pistacia terebinthus oil are also advantageously used in the context of the present invention.

Preferably, the fats present in cookies are chosen from mixtures of fats and vegetable oils (coconut, palm, rapeseed, olive, sunflower, soybean, etc), butters and margarines. The butters can be used in the form of pastry butter (fat content generally greater than 82% by weight) or as they are (generally consisting of 82% by weight of fat and 18% by weight of water). Other qualities of butter in which the fat content may be greater than or less than 82% by weight are also advantageously present in cookies. Margarines are emulsions of vegetable fats with water.

Preferably, the fats present in chocolate are those described in directive 2000/36/EC. They are in particular cocoa butter, illipe butter (in particular Borneo illipe or Tengkawang), palm oil, sal, shea, kokum gurgi and mango kernels.

The term “sugars” is intended to mean monosaccharide- and disaccharide-based molecules. More particularly, the following sugars are preferred:
semi-white sugar, which contains more than 99.6% of sucrose,
white sugar, which contains more than 99.8% of sucrose,
confectioner's sugar or white sugar ground to a very fine powder,
invert sugar, which is an equimolar mixture of glucose and fructose, obtained by hydrolysis of sucrose,
liquid invert sugar, aqueous solution of invert sugar,
invert sugar syrup,
glucose and glucose syrup,
dehydrated glucose syrup,
dextrose monohydrate, anhydrous dextrose,
fructose and fructose syrup,
sugar candy,
brown sugar or cane sugar (containing 95% of sucrose),
glucose-fructose syrup, and
lactose.

Also included among the sugars present in the food compositions of the invention are the various sugars according to their degree of refining. Said sugars may be in solid or liquid form.

In the context of the present invention, the compound of vanillin and ethyl vanillin can be mixed with at least one excipient, which must have the property of food quality. This excipient makes it possible to improve the flowability of the pure compound of vanillin and ethyl vanillin.

Without wishing to be bound by a theory, the excipient makes possible to improve the affinity of the compound of vanillin and ethyl vanillin for sugars and its solubility in water, making the compound more available. The compound of vanillin and ethyl vanillin, by virtue of its miscibility in aqueous solvents, in particular sugar syrups, and its physicochemical properties, also mixes well in a food composition not containing fat. The use of the excipient is therefore particularly advantageous in food products which do not contain fat and which have a reduced sugar content.

The subject of the present invention is therefore also the use according to the invention of the compound of vanillin and ethyl vanillin mixed with at least one excipient chosen from the group consisting of fatty acids, optionally in salt or ester form; fatty alcohols; polyoxyethylenated fatty alcohols; waxes; sugars; polysaccharides; calcium stearate, yeasts and baking powders, and silica.

The amount of excipient(s) may be very variable and may represent from 0.1% to 99.9% by weight of the weight of the compound of vanillin and ethyl vanillin and of the excipient.

It is advantageously chosen between 10% and 90% by weight, very advantageously between 20% and 60% by weight, relative to the total weight of the compound of vanillin and ethyl vanillin and of the excipient.

Thus, in the context of the present invention, the excipient is between 0.1% and 99.9% by weight, relative to the total weight of the compound of vanillin and ethyl vanillin and of the excipient.

Depending on the type of excipient selected, the amount used and the purpose of the final product, the excipient can be either added by dry mixing with the compound of vanillin and ethyl vanillin, or incorporated in the process of obtaining the compound of vanillin and ethyl vanillin, for example during the step of melting the vanillin and ethyl vanillin mixture, as described in application EP 2 365 760.

Examples of excipients that may be used are given below, and are given without any limiting nature.

Examples that may be mentioned include fatty acids optionally in the form of salts or esters.

The fatty acids used as excipients are generally long-chain saturated fatty acids, i.e. having a chain length of approximately between 9 and 21 carbon atoms, for instance capric acid, lauric acid, myristic acid, palmitic acid, stearic acid, arachidic acid, caproic acid and behenic acid.

It is possible for said acids to be in salified form, and mention may be made in particular of calcium stearate or magnesium stearate.

Fatty acid esters that may be mentioned as excipients include in particular glyceryl stearate, isopropyl palmitate, cetyl palmitate and isopropyl myristate.

Mention may also be made more specifically of long-chain fatty acid esters of glycerol, such as glyceryl monostearate, glyceryl monopalmitostearate, glyceryl palmitostearate, ethylene glycol palmitostearate, polyglyceryl palmitostearate, polyglycol 1500 and 6000 palmitostearate, glyceryl monolinoleate; optionally mono- or diacetylated long-chain fatty acid esters of glycerol such as monoacetylated or diacetylated monoglycerides and mixtures thereof; and semisynthetic glycerides.

A fatty alcohol of which the carbon atom chain comprises from 16 to 22 carbon atoms may also be added as excipient, for instance myristyl alcohol, palmityl alcohol or stearyl alcohol.

It is also possible to use as excipients polyoxyethylenated fatty alcohols resulting from the condensation of ethylene oxide in a proportion of from 6 to 20 mol of ethylene oxide per mole, linear or branched fatty alcohols containing from 10 to 20 carbon atoms, for instance coconut alcohol, tridecanol or myristyl alcohol.

As excipients, mention may also be made of waxes such as microcrystalline waxes, white wax, carnauba wax or paraffin.

By way of excipients, mention may be made of sugars, for instance glucose, sucrose, fructose, galactose, ribose, maltose, sorbitol, mannitol, xylitol, lactitol and maltitol; invert sugars; glucose syrups and also sucroglycerides derived from fatty oils, such as coconut oil, palm oil, hydrogenated palm oil and hydrogenated soybean oil; sucrose esters of fatty acids, such as sucrose monopalmitate, sucrose monodistearate and sucrose distearate.

Examples of other excipients that may be mentioned include polysaccharides, and mention may be made, inter alia, of the following products and mixtures thereof:
starches derived in particular from wheat, corn, barley, rice, cassava or potato, in native, pregelatinized or modified form and more particularly native corn starches rich in amylose, pregelatinized corn starches, modified corn starches, modified waxy corn starches, pregelatinized waxy corn starches and modified waxy corn starches, in particular the starch OSSA/sodium octenylsuccinate,
starch hydrolysates,
dextrins and maltodextrins resulting from the hydrolysis of a starch (wheat or corn starch) or of a tuber starch (potato starch), and also β-cyclodextrins,
cellulose, ethers thereof, in particular methylcellulose, ethylcellulose, methylethylcellulose or hydroxypropylcellulose; or esters thereof, in particular carboxymethylcellulose or carboxyethylcellulose, optionally in sodium form. The hydroxyl (—OH) groups of cellulose can partially or totally react with various chemical reagents to give cellulose ethers, of formula —OR, with R being a (C₁-C₁₀)alkyl, optionally substituted with at least one OH group, or cellulose esters of formula —OR′, with R′ being a —C(O)—(C₁-C₁₀)alkyl group,
gums such as kappa-carrageenan or iota-carrageenan gum, pectin, guar gum, locust bean gum and xanthan gum, alginates, gum arabic, acacia gum or agar-agar.

The excipient is preferentially chosen from the group consisting of the maltodextrins resulting from the hydrolysis of a starch or of a tuber starch and also β-cyclodextrins, preferably maltodextrins having a degree of hydrolysis measured by “dextrose equivalent” or D.E of less than 20 and preferably between 5 and 19 and more preferentially between 6 and 15.

According to one embodiment, the excipient chosen is a maltodextrin.

Other excipients that may be mentioned include flours, in particular (native or pregel) wheat flour; tuber starches, more particularly potato starch, canna starch, corn starch (maizena), rice starch, sago or tapioca.

An excipient that may also be used is gelatin (preferably having a gel force measured using a gelometer of 100, 175 and 250 Bloom). It may be of porcine, bovine or marine (fish) origin.

It is also possible to add other excipients, such as silica or else, for example, an antioxidant, such as, in particular, vitamin E or an emulsifying agent, in particular lecithin or else one or more raising agents, for example a baking powder (sodium phosphate and/or bicarbonate).

In order to adjust the aromatic power of the mixture or to increase its taste, one or more flavorings belonging in particular to the sweet field, such as butter, caramel, honey, cookie or almond flavorings, fruit flavorings (lemon essence, orange flower, etc), flavorings belonging to the hot range, in particular hazelnut or chocolate, is (are) advantageously added. For example, the use of ethylmaltol (caramel) and/or of propenyl guaethol can be envisioned.

The choice of excipients is made, as mentioned previously, as a function of the intended use.

The fields of application of the invention are mainly the dry cookie trade and cake-making field, in particular factory-baked cake field; the chocolate confectionary field, in particular for the preparation of bars of chocolate, of couverture chocolates or of filling for chocolates; during the production of candies of any type: sugar-coated candies, caramels, nougats, hard candies, soft candies and the like; the dairy industry and more particularly flavored and gelled milks, cream desserts, yoghurts, ices and ice creams; the preparation of pastry cream; the preparation of various drinks, preferably grenadine and chocolate-flavored drinks; the preparation of instant drinks, such as powdered flavored drinks, chocolate powders or else instant preparations in powder form intended for making desserts of any type.

According to one particular embodiment, the abovementioned compound of vanillin and ethyl vanillin is used in the context of the invention in the dry cookie trade and cake-making field, in particular the factory-baked cake field; in the chocolate confectionary field, in particular for the preparation of bars of chocolate, of couverture chocolates or of filling for chocolates.

Among the preferred fields of use, according to the invention, of the compound of vanillin and ethyl vanillin, mention may in particular be made of that of the cookie trade and cake-making field, and more particularly:
the dry cookie trade for the preparation of sweet cookies of standard type, butter cookies, large round cookies, snacks or shortbread,
the factory-baked cake field for the preparation of champagne ladyfingers, thin fingers, sponge fingers, Genoa cake, sponge cake, brioches, madeleines, pound cake, fruit cakes, almond-based cakes and petits-fours, and
the preparation of creams, in particular of pastry cream, of custard and of Chantilly cream.

The present invention also has an advantageous application in the field of animal feeds.

According to one embodiment of the invention, the use of the compound of vanillin and ethyl vanillin, optionally mixed with an excipient, is particularly suitable for the field of food products with a reduced fat and/or sugar content as defined above.

The use according to the invention is particularly suitable for food products with a reduced fat and/or sugar content in the abovementioned fields. The use according to the invention is more particularly suitable for food products with a reduced fat and/or sugar content in the dry cookie trade and factory-baked cake field, and also for food products with a reduced fat and/or sugar content in the chocolate confectionary field.

According to the invention, the food product with a reduced fat and/or sugar content also comprises at least one flavoring, such as vanillin.

The other possible flavorings belong in particular to the sweet field, such as butter, caramel, honey, cookie or almond flavorings, fruit flavorings (lemon essence, orange flower, etc), flavorings belonging to the hot range, in particular hazelnut and chocolate.

Another aspect of the invention relates to a composition with a reduced fat and/or sugar content comprising a compound of vanillin and ethyl vanillin in a vanillin/ethyl vanillin molar ratio of 2, having a melting point of 60° C.±2° C., at least one fat and/or at least one sugar, in which the amount of fat(s) and/or of sugar(s) is decreased compared with the amount of fat(s) and/or of sugar(s) present in a food composition with a non-reduced fat and/or sugar content. Advantageously, said composition with a reduced fat and/or sugar content is such that the amount of fat(s) and/or of sugar(s) is decreased by at least 0.1% by weight, preferably by at least 0.5% by weight, more preferably by at least 1% by weight and even more preferably by at least 5% by weight, compared with the amount of fat(s) and/or of sugar(s) present in a food composition with a non-reduced fat and/or sugar content. Said composition with a reduced fat and/or sugar content is such that the amount of fat(s) and/or of sugar(s) is advantageously decreased by at most 80% by weight, preferably by at most 50% by weight, more preferably by at most 30% by weight and even more preferably by at most 25% by weight, compared with the amount of fat(s) and/or of sugar(s) present in a food composition with a non-reduced fat and/or sugar content.

According to one particular embodiment, the composition with a reduced fat and/or sugar content comprises a compound of vanillin and ethyl vanillin in a vanillin/ethyl vanillin molar ratio of 2, having a melting point of 60° C.±2° C., at least one fat and/or at least one sugar, in which the amount of fat(s) and/or of sugar(s) is decreased by 5% to 20% by weight, preferably by 5% to 15% by weight, compared with the amount of fat(s) and/or of sugar(s) present in a food composition with a non-reduced fat and/or sugar content.

It has been noted that the food compositions with a reduced fat and/or sugar content according to the invention have gustatory properties which are stable on cooking.

According to one embodiment, the food composition with a reduced fat and/or sugar content is characterized in that the compound of vanillin and ethyl vanillin has an x-ray diffraction spectrum with several characteristic lines at angles 26 (in)°=20.7−25.6−27.5−28.0 (measured relative to the copper K-Alpha1 line=1.54060 Å), said lines not being present in the x-ray diffraction spectrum of pure vanillin or of pure ethyl vanillin.

According to one particular embodiment, the compound of vanillin and ethyl vanillin is between 0.001% and 0.2% by weight, relative to the total weight of the food composition with a reduced fat and/or sugar content. Said compound is as described above, and corresponds to the product described in application EP 2 365 760.

The preparation of the food products, with a reduced or non-reduced fat and/or sugar content, is explained in detail below.

The fundamental elements present in the mixtures intended for the abovementioned industries are proteins (gluten) and starch, which are usually provided by wheat flour. For the preparation of the various types of cookies and cakes, ingredients such as sucrose, salt, eggs, milk, fats as previously described, optionally chemical raising agents (sodium bicarbonate or other artificial raising agents) or biological yeasts and various cereal flours (etc.) for preparing a dough are added to the flour.

The incorporation of the compound of vanillin and ethyl vanillin is performed during the production, according to the desired food product, and is carried out according to the standard techniques of the field under consideration (cf. in particular J. L. Kiger and J. C. Kiger—Techniques Modernes de la Biscuiterie, Patisserie-Boulangerie industrielles et artisanales, Dunod, Paris, 1968, Volume 2, pp. 231 et seq.).

Preferentially, the compound of vanillin and ethyl vanillin is introduced into the fats which are involved in the preparation of the dough.

By way of indication, it will be pointed out that the compound of vanillin and ethyl vanillin is, for example, advantageously introduced in an amount of from 0.005 g to 0.2 g per kg of dough.

The compound of vanillin and ethyl vanillin is entirely suitable for use in the chocolate confectionery field, irrespective of the form of implementation: bars of chocolate, couverture chocolates, filling for chocolates.

For example, said compound may be introduced during the conching, i.e. the blending of the cocoa paste with the various ingredients, in particular the flavorings, or after conching, by using it in cocoa butter.

In this field of application, the compound of vanillin and ethyl vanillin is used, according to the type of chocolate, in a proportion of from 0.0005 g to 0.1 g per 1 kg of final product: the highest contents being found in couverture chocolate.

Another use according to the invention of said compound is the production of candies of any type: sugar-coated candies, caramels, nougats, hard candies, soft candies and the like.

The compound of vanillin and ethyl vanillin is very suitable for uses according to the invention in the dairy industry and more particularly in flavored and gelled milks, cream desserts, yoghurts, ices, ice creams and the preparation of pastry cream.

The compound of vanillin and ethyl vanillin may also be incorporated into various drinks, and mention may be made, inter alia, of grenadine and chocolate-flavored drinks. In particular, this compound may be used in preparations for instant drinks dispensed by automatic drink dispensers, flavored powdered drinks or chocolate powder, or alternatively in instant preparations in powder form intended for making desserts of any type, flans, cake mixes or pancakes, after dilution with water or with milk.

The amount of the compound of vanillin and ethyl vanillin introduced depends on the more or less pronounced taste that is desired. Thus, the doses for use of said compound can vary between 0.001% and 0.2% by weight.

The aromatization is carried out by simple addition of the compound of vanillin and ethyl vanillin, in one of the mixing stages required during the production of the food product with a reduced or non-reduced fat and/or sugar content.

The contents of said compound to be used are generally low, of the order of 0.02 g per 1 kg of final product.

During the preparation of food products with a reduced fat and/or sugar content, it is possible for the amount of at least one of the other ingredients to be increased, so as to compensate for the loss of weight linked to the decreasing the amount of fat(s) and/or of sugar(s). This compensation allows manufacturers in the sector to keep their recipes and their preparation processes identical to the food products with a non-reduced fat and/or sugar content.

The present invention therefore makes it possible to obtain food compositions with a reduced fat and/or sugar content which are of interest both in terms of health and industrially, as shown in the examples below.

### EXAMPLES

### Example 1

Preparation of the mixture of the compound of vanillin and ethyl vanillin with an excipient 2100 g of powdered vanillin (VA) and 900 g of ethyl vanillin (EVA), i.e. a VA/EVA weight ratio=70/30, are introduced into a plowshare mixer equipped with a tank having a volume of 15 liters, heated by a jacket. The moisture content of these powders is 0.1% by weight.

The stirrer is switched on at a speed of 20 revolutions/min, i.e. a blade-tip speed of 0.25 m/s. This stirring speed is kept constant throughout the phases of the process.

A circulation of wet nitrogen is established in the mixer at a flow rate of 200 I/h. Humidification of the nitrogen stream is ensured by sparging it through water maintained at 40° C. so as to obtain 25 g of water per kg of nitrogen. The feed line between the water bath and the mixer is maintained at 45° C. so as to avoid any condensation in the pipes.

The temperature of the heat-transfer fluid circulating in the jacket is gradually increased such that the temperature of the mixture of powders follows a ramp of +0.3° C./min.

When the temperature of the product reaches 49.5° C., the water bath humidifying the nitrogen stream is bypassed so as to feed the mixture with a circulation of dry nitrogen (less than 0.5 g of water/kg of nitrogen). At the same time, 150 g of maltodextrin (Roquette IT 12) are introduced into the mixer.

The temperature of the product is brought from 49.5° C. to 52° C. at +0.2° C./min and is maintained at 52° C. for 30 minutes. The heating of the heat-transfer fluid is then stopped and, by natural cooling, the temperature of the product is brought to 30° C. The stirring and the nitrogen circulation are stopped. The mixture is emptied.

The product is screened through 800 μm; the undersize represents 56% by weight of the total weight. The oversize at 800 μm is milled using a Quadro Comill mill fitted with an 800 μm screen. The two fractions are then combined and the mixture is homogenized so as to give the final product.

In all of the following examples, the compound of vanillin and ethyl vanillin is used as described above, i.e. mixed with maltodextrin, in a VA/EVA weight ratio of 70/30, at 60% by weight of maltodextrin.

### Example 2

### Preparation of Shortbread Cookies with a Reduced Butter Content

Shortbread cookies with a non-reduced butter content are prepared according to the following three compositions (compositions 1, 2 and 3).

| Ingredients/ | | | Composition 3 |
|---|---|---|---|
| Composition | Composition 1 | Composition 2 | (Invention) |
| Wheat flour | 400 g | 400 g | 400 g |
| | (42.2% by weight) | (42.1% by weight) | (42.1% by weight) |
| Powdered | 200 g | 200 g | 200 g |
| white sugar | (21.0% by weight) | (21.0% by weight) | (21.0% by weight) |
| Egg | 100 g | 100 g | 100 g |
| | (10.5% by weight) | (10.5% by weight) | (10.5% by weight) |
| Butter | 250 g | 250 g | 250 g |
| | (26.3% by weight) | (26.3% by weight) | (26.3% by weiqht) |
| Flavoring | 0 | 0.5 (a) | 0.5 (b) |
| (Rhovanil ® | | (0.1% by weight) | (0.1% by weight) |
| vanillin (a) or | | | |
| compound | | | |
| of vanillin | | | |
| and ethyl | | | |
| vanillin (b)) | | | |
| Water | 0 | 0 | 0 |
| Total | 950 g | 950.5 g | 950.5 g |
| | (100%) | (100%) | (100%) |

″% by weight″ indicates the percentage by weight relative to the total weight of the composition.

Shortbread cookies with a reduced butter content are also prepared, according to the following three compositions (compositions 4, 5 and 6).

| Ingredients/ | | | Composition 6 |
|---|---|---|---|
| Compositions | Composition 4 | Composition 5 | (Invention) |
| Wheat flour | 400 + 50 g | 400 + 50 g | 400 + 50 g |
| | (47.5% by weight) | (47.4% by weight) | (47.4% by weight) |
| Powdered | 200 g | 200 g | 200 g |
| white sugar | (21.0% by weight) | (21.0% by weight) | (21.0% by weight) |
| Egg | 100 g | 100 g | 100 g |
| | (10.5% by weight) | (10.5% by weight) | (10.5% by weight) |
| Butter | 200 g | 200 g | 200 g |
| | (21.0% by weight) | (21.0% by weight) | (21.0% by weight) |
| Flavoring | 0 | 0.5 (a) | 0.5 (b) |
| (Rhovanil ® | | (0.1% by weight) | (0.1% by weight) |
| vanillin (a) or | | | |
| compound | | | |
| of vanillin | | | |
| and ethyl | | | |
| vanillin (b)) | | | |
| Water | 0 | 0 | 0 |
| Total | 950 g | 950.5 g | 950.5 g |
| | (100%) | (100%) | (100%) |

″% by weight″ indicates the percentage by weight relative to the total weight of the composition.

### Preparation of the Shortbread Cookies:

The flour is weighed out in a mixing bowl.
The sugar, weighed out in another container, is added to the flour.
The solid flavoring is added to the previous premix of powders while mixing with a metal whisk by hand.
The butter, slightly melted in a microwave, is incorporated into the previous mixture.
The pre-weighed liquid eggs are added to the container having been used to blend the butter into the dough and the dough is homogenized.
The bottom of the container having been the used for the eggs-butter addition is scraped with a Maryse spatula so as to recover the maximum amount of product.
The mixture is mixed with stirring in a dough mixer (brand Matfer) “power 3”/2 minutes.
The dough ball is left in the refrigerator while the other recipes are prepared, so that it becomes firmer.
The dough ball is rolled out and cut up with a cutter so as to form each cookie.
Baking is carried out in a hot oven at 180° C. for 12 minutes.
The cookies are then cooled to ambient temperature.

### Sensory Analysis:

The sensory analysis according to a triangle test was carried out in accordance with standard ISO 4120/2004 relating to triangle tests. The sensory analysis is carried out on a panel made up of 7 to 11 people.

In the absence of flavoring, the subjects distinguish between the shortbread cookies comprising 200 g of butter (composition 4) and 250 g of butter (composition 1) on the basis of the butter note, which is less pronounced for the cookie containing 200 g of butter.

This distinction is also made between the shortbread cookies comprising 200 g of butter (composition 5) and those comprising 250 g thereof (composition 2), when the shortbread cookies are flavored at 0.1% by weight of vanillin. The distinction is made on the basis of the lower butter note of the shortbread cookie containing 200 g of butter.

With an aromatization with 0.1% by weight of the compound of vanillin and ethyl vanillin, the shortbread cookie containing 200 g of butter (composition 6) is not distinguished from the cookie containing 250 g of butter (composition 3) by the test subjects.

The shortbread cookie of composition 6 with a reduced butter content is also found to be sweeter and to have more of a vanilla flavor than the shortbread cookie of composition 3 with a non-reduced butter content.

Consequently, the compound of vanillin and ethyl vanillin makes it possible to obtain a gustatory sensation of roundness in the mouth, for a cookie with a reduced butter content, which is identical to or even greater than that of a cookie with a non-reduced butter content.

### Example 3

### Preparation of Shortbread Cookies with a Reduced Butter Content

The same procedure as for example 1 is used. Four types of shortbread cookies are prepared using the following four recipes (recipes A, B, C and D).

| | Recipe A | | Recipe B | |
|---|---|---|---|---|
| | | as % by | | as % by |
| | in grams | weight | in grams | weight |
| Wheat flour | 450 | 47.5 | 450 | 47.5 |
| Powdered white sugar | 200 | 21.0 | 200 | 21.0 |
| Egg | 80 | 8.4 | 100 | 10.5 |
| Butter | 220 | 23.1 | 200 | 21.0 |
| Vanillin/ethyl vanillin | 0 | 0 | 0 | 0 |
| compound | | | | |
| Total | 950 | 100.0 | 950 | 100 |
| | Recipe C | | Recipe D | |
| | (Invention) | as % by | (Invention) | as % by |
| | in g | weight | in g | weight |
| Wheat flour | 450 | 47.447 | 450 | 47.437 |
| Powdered white sugar | 200 | 21.0 | 200 | 21.0 |
| Egg | 80 | 8.4 | 100 | 10.5 |
| Butter | 220 | 23.1 | 200 | 21.0 |
| Vanillin/ethyl vanillin | 0.5 | 0.053 | 0.6 | 0.063 |
| compound | | | | |
| Total | 950.5 | 100.0 | 950.6 | 100 |

″% by weight″ indicates the percentage by weight relative to the total weight of the composition.

### Sensory Analysis:

The sensory analysis according to a triangle test was carried out in accordance with standard ISO 4120/2004 relating to triangle tests. The sensory analysis is carried out on a panel made up of 7 to 11 people.

In the absence of aromatization, the recipe A is clearly distinguished from the recipe B on the basis of the butter note, which is less pronounced for the cookie containing 21% of butter.

On the other hand, with an aromatization with 0.063% by weight of the compound of vanillin and ethyl vanillin according to the recipe D, the recipe D containing 21% by weight of butter is no longer distinguished from the recipe C, containing 23% by weight of fat and 0.053% by weight of the compound of vanillin and ethyl vanillin.

An increase of 20% by weight in the amount of the compound of vanillin and ethyl vanillin therefore makes it possible to compensate for the loss of gustatory sensation of roundness in the mouth for a food composition of which the amount of fat has been reduced by 10% (i.e. 2% relative to the entire recipe).

The shortbread cookies according to the recipes C and D comprising the compound of vanillin and ethyl vanillin are found to be sweeter and to have more of a vanilla flavor than the shortbread cookies according to the recipes A and B. The shortbread cookies according to the recipe D with a reduced fat content are also found to be sweeter and have more of a vanilla flavor than the cookies according to the recipe C.

Consequently, an increase in the amount of the compound of vanillin and ethyl vanillin makes it possible to compensate for the loss of roundness in the mouth due to the decrease in the amount of butter in a cookie.

### Example 4

### Preparation of a Meringue with a Reduced Sugar Content

Meringues are prepared according to the following two recipes A and B:

| | | | Recipe with a reduced | |
|---|---|---|---|---|
| | | | sugar content B | |
| Meringue | Recipe A | | (Invention) | |
| Ingredients | (grams) | % by weight | (grams) | % by weight |
| Egg white | 200 | 34.5 | 250 | 45.83 |
| Confectioner's sugar | 100 | 17.2 | 125 | 22.90 |
| Sugar | 280 | 48.3 | 170 | 31.20 |
| Compound of vanillin and | 0 | 0.00 | 0.4 | 0.07 |
| ethyl vanillin | | | | |
| Total | 580 | 100 | 545.4 | 100 |

### Preparation of Meringues:

Weigh out the egg whites in the bowl of a beater (Kitchenaid).
Whisk the whites at medium speed (approximately 6).
Weigh out the two sugars (granulated sugar+confectioner's sugar) and combine them in one and the same container.
Add the flavoring to the sugars and make into a homogeneous mixture with a spoon.
After 6 minutes of whisking, add the sugars in 2 to 3 parts with maximum stirring in order to properly stiffen the eggs.
Whisk the mixture for 12 minutes.
Fill the piping bags of the apparatus and make small rosettes 3 to 4 cm in diameter on baking paper.
Put in a hot oven at 80° C. for 3 hours.

In the recipe B, the amount of confectioner's sugar was increased for a better hold of the meringue.

However, the total sugar content of the recipe B (295 g) remains less than the recipe A (380 g).

### Sensory Analysis:

The sensory analysis according to a triangle test was carried out on a panel made up of 11 people in accordance with standard ISO 4120/2004 relating to triangle tests.

The presence of the compound of vanillin and ethyl vanillin compensates for the loss of roundness in the mouth due to the reduced sugar content, without impairing the texture of the meringues, and gives the meringues a vanilla flavor that is more pronounced than that of the meringues according to the recipe A.

The meringues comprising the compound of vanillin and ethyl vanillin withstand lengthy baking at a temperature of 80° C., just as the compound of vanillin and ethyl vanillin also withstand these conditions.

### Example 5

### Preparation of an Anhydrous Chocolate Filling for Use in Cookies in Sandwich Form

Anhydrous chocolate fillings are prepared according to the following three compositions (compositions 1, 2 and 3).

| | | | | | Composition 3 | |
|---|---|---|---|---|---|---|
| Ingredients/ | | | | | (Decrease in | |
| Composition | Composition 1 | | Composition 2 | | cocoa content) | |
| Confectioner's sugar | 335.5 g | (55.92%) | 335.5 g | (55.9%) | 353.5 g | (58.92%) |
| Solid vegetable fat | 186 g | (31.0%) | 186 g | (31.0%) | 186 g | (31.0%) |
| Cocoa | 78 g | (13%) | 78 g | (13%) | 60 g | (10%) |
| Flavoring vanillin (a) | 0.5 g | (b) (0.08%) | 0.5 g | (a) (0.08%) | 0.5 g | (b) (0.08%) |
| or compound of | | | | | | |
| vanillin and ethyl | | | | | | |
| vanillin (b)) | | | | | | |
| Total | 600 g | (100%) | 600 g | (100%) | 600 g | (100%) |

Preparation of the fillings:
The fat is a melted at 50° C.
The confectioner's sugar, the cocoa and the flavoring are weighed out in a mixing bowl and mixed.
The three powders are poured into a Thermomix.
The melted fat is added with stirring while maintaining a temperature of 50° C.
The stirring is continued at speed 3 for 3 minutes.
For tasting, the filling is deposited hot between two cookies of “butter cookie” type in a proportion of ⅓ of filling to ⅔ of cookie.

### Sensory Analysis:

The sensory analysis is carried out according to a classification test. The panellists are asked to classify the three recipes according to the aromatic power experience, giving a note between 1 and 10.

11 panellists participated in this tasting.

The results are as follows.

In the presence of the compound of vanillin and ethyl vanillin, the chocolate fillings (compositions 1 and 3) have a much higher aromatic power than that of the filling flavored with vanillin (composition 2), despite the 23% decrease in cocoa in composition 3.

Consequently, the compound of vanillin and ethyl vanillin makes it possible to obtain a greater gustatory sensation while reducing the cocoa content in recipes for anhydrous chocolate filling for cookies.

1. A method comprising incorporating, in a food product, a compound of vanillin and ethyl vanillin in a vanillin/ethyl vanillin molar ratio of 2, having a melting point of 60° C.±2° C., for conferring a gustatory sensation of roundness in the mouth.

2. The method as claimed in claim 1, being for reinforcing a gustatory sensation of roundness in the mouth.

3. The method as claimed in claim 1, being for compensating for loss of flavoring and loss of roundness in the mouth due to a decrease of at least 0.1% by weight in the amount of fat(s) and/or of sugar(s) for the food product with a reduced fat and/or sugar content compared with a food composition with a non-reduced fat and/or sugar content.

4. The method as claimed in claim 1, wherein the compound of vanillin and ethyl vanillin has an x-ray diffraction spectrum with several characteristic lines at angles 2θ (in)°=20.7−25.6−27.5−28.0 measured relative to the copper K-Alpha1 line=1.54060 Å, said characteristic lines at angles 2θ (in)° not being present in the x-ray diffraction spectrum of pure vanillin or of pure ethyl vanillin.

5. The method as claimed in claim 1, wherein the gustatory sensation of roundness in the mouth is characterized by at least one taste sensation selected from the group consisting of a creamy taste, a milk fat taste, a butter taste, a sweet taste, adhesion and fullness in the mouth.

6. The method as claimed in claim 1, wherein the compound of vanillin and ethyl vanillin is mixed with at least one excipient selected from the group consisting of fatty acids, optionally in salt or ester form; fatty alcohols; polyoxyethylenated fatty alcohols; waxes; sugars; polysaccharides; sodium stearate, yeasts and baking powders, and silica.

7. The method as claimed in claim 6, wherein the excipient is selected from the group consisting of:
sugars; invert sugars; glucose syrups and also sucroglycerides derived from fatty oils; sucrose esters of fatty acids,
starches derived from wheat, corn, barley, rice, cassava or potato, in native, pregelatinized or modified form,
starch hydrolysates,
dextrins and maltodextrins resulting from the hydrolysis of a starch or of a tuber starch, and also β-cyclodextrins,
cellulose, ethers thereof, or esters thereof,
gums,
flours; tuber starches,
gelatin,
silica,
antioxidants, and
emulsifiers.

8. The method as claimed in claim 6, wherein the excipient is selected from the group consisting of maltodextrins resulting from the hydrolysis of a starch or of a tuber starch and β-cyclodextrins.

9. The method as claimed in claim 6, wherein the excipient is between 0.1% and 99.9% by weight, relative to the total weight of the compound of vanillin and ethyl vanillin and of the excipient.

10. The method as claimed in claim 1, being used in the dry cookie trade and cake-making field; in the chocolate confectionery field; during the production of candies of any type; in the dairy industry; in the preparation of pastry cream; in the preparation of various drinks; in the preparation of instant drinks, or in instant preparations in powder form intended for making desserts.

11. The method as claimed in claim 1, being used in the dry cookie trade and factory-baked cake field; or in the chocolate confectionery field.

12. The method as claimed in claim 1, wherein the food product also comprises at least one flavoring.

13. The method as claimed in claim 1, being used in the field of animal feeds.

14. A food composition with a reduced fat and/or sugar content comprising a compound of vanillin and ethyl vanillin in a vanillin/ethyl vanillin molar ratio of 2, having a melting point of 60° C.±2° C., at least one fat and/or at least one sugar, in which the amount of fat(s) and/or of sugar(s) is decreased by at least 0.1% by weight compared with the amount of fat(s) and/or of sugar(s) in a food composition with a non-reduced fat and/or sugar content.

15. The food composition with a reduced fat and/or sugar content as claimed in claim 14, wherein the compound of vanillin and ethyl vanillin has an x-ray diffraction spectrum with several characteristic lines at angles 2θ (in)°=20.7−25.6−27.5−28.0 measured relative to the copper K-Alpha1 line=1.54060 Å, said characteristic lines at angles 2θ (in)° not being present in the x-ray diffraction spectrum of pure vanillin or of pure ethyl vanillin.

16. The food composition with a reduced fat and/or sugar content as claimed in claim 14, wherein the compound of vanillin and ethyl vanillin is between 0.001% and 0.2% by weight, relative to the total weight of the composition.

17. The method as claimed in claim 6, wherein the excipient is a starch selected from the group consisting of pregelatinized corn starches, modified corn starches, modified waxy corn starches, pregelatinized waxy corn starches, and modified waxy corn starches.
